(19) United States
(12) Patent Application Publication
(10) Pub. No.: US 2014/0250985 A1
(43) Pub. Date: Sep. 11, 2014

(54) SENSING SENSOR AND SENSING DEVICE USING PIEZOELECTRIC RESONATOR

(71) Applicant: Nihon Dempa Kogyo Co., Ltd., Tokyo (JP)

(72) Inventors: WAKAKO SHINOBU, SAITAMA (JP); HIROYUKI KUKITA, SAITAMA (JP); SHUNICHI WAKAMATSU, SAITAMA (JP)

(73) Assignee: Nihon Dempa Kogyo Co., Ltd., Tokyo (JP)

(21) Appl. No.: 14/195,870

(22) Filed: Mar. 4, 2014

(30) Foreign Application Priority Data
Mar. 7, 2013 (JP) 2013-045396

(51) Int. Cl. G01N 29/02

(52) U.S. Cl. CPC G01N 29/022
USPC 73/64.53

(57) ABSTRACT

A sensing sensor includes a crystal element having a first excitation electrode, a second excitation electrode, and a common electrode, an adsorbing layer, a wiring board, and a channel forming member. The crystal element is secured to the wiring board so as to form a space at one surface side of the first vibrating region and the second vibrating region. The channel forming member is disposed to form a supply channel of sample solution upward of each of the first vibrating region and the second vibrating region. The channel forming member is disposed such that an inferior surface of a left edge and a right edge of the channel forming member is positioned on the common electrode. The channel forming member is formed such that an injection port of the sample solution and a discharge port of the sample solution are opposed to the crystal element.

### CROSS-REFERENCE TO RELATED APPLICATION

This application claims the priority benefit of Japanese application serial no. 2013-045396, filed on Mar. 7, 2013. The entirety of the above-mentioned patent applications is hereby incorporated by reference herein and made a part of specification.

### TECHNICAL FIELD

The present disclosure relates to a technique to sense an object to be sensed using a piezoelectric resonator where a unique vibration frequency changes when the object to be sensed is absorbed by an adsorbing layer disposed at a surface of the sensing sensor.

### DESCRIPTION OF THE RELATED ART

For example, a sensing sensor utilizing Quartz Crystal Microbalance (QCM) as disclosed in Japanese Unexamined Patent Application No. 2009-206792 is shown as a method for sensing an object to be sensed in a sample fluid such as a trace amount of protein in blood or serum. The QCM uses a crystal unit with an adsorbing layer that adsorbs the object to be sensed to a surface of an excitation electrode by antigen-antibody reaction. A load by the mass of the adsorbed object to be sensed in a sample solution is grasped by frequency change of the crystal unit, thus the object to be sensed is quantitated. The use of the basic principle allows application to simple measurement employed for diagnosis in a medical front and food inspection.

In this respect, the sensing sensor uses a microfluidic chip and forms extremely narrow reaction space within which antigen-antibody reaction is conducted. The microfluidic chip is made of polydimethylsiloxane (PDMS). Placing the microfluidic chip on a dedicated QCM sensor creates a minute reaction portion. Since the use of the microfluidic chip allows considerable reduction in reaction capacity, the sample passes through the surface of the electrode without diluting. This is advantageous of high sensitivity of low-concentration sample.

Currently, the microfluidic chip used for the sensing sensor is designed at a channel height of 300 μm and with the reaction capacity of approximately 5 μL. Japanese Unexamined Patent Application Publication No. 2011-27716 discloses a sensing sensor where the channel height of the microfluidic chip is narrowed down to 100 μm to form a more tiny space and therefore sensitivity of the sensing sensor to samples is increased. Further, for example, with the sensing sensor with the channel height narrowed down to 50 μm, the capacity becomes 0.83 μL and its sensitivity is increased from the above-described theory. However, designing the microfluidic chip at the channel height of 50 μm arises the following problems.

First, the QCM sensor used is constituted of two gold electrodes. Configuring one of the electrodes as a reference ensures differential measurement. However, since the thickness of the gold electrodes is 400 nm, in the case where hydrophobicity of the surfaces of the two electrodes is high when the sample solution is added from the inlet, the sample solution avoids the gold electrodes and exits from the outlet trickling the surrounding crystal. If a hydrophilic adsorbing layer for adsorbing the object to be sensed is disposed only at an electrode for detection among the two electrodes, hydrophilicity differs between each of the electrodes. In that case, the sample solution does not flow to the electrode of lower hydrophilicity, which may cause failure of measurement. These problems do not occur only if the thickness of the gold electrodes is thinned to 100 nm. However, there is a problem of deterioration of sensor characteristics when the thickness of the gold electrode is below 100 nm.

Therefore, under the aforementioned circumstances, there would be a need for a device that ensures a stable measurement of a low concentrate sample of objects to be sensed in a sample solution.

### SUMMARY

A sensing sensor of the present disclosure includes a first excitation electrode, a second excitation electrode, a common electrode, an adsorbing layer, a wiring board, and a channel forming member. The first excitation electrode and the second excitation electrode are disposed at one surface side of a crystal element. The first excitation electrode and the second excitation electrode are laterally separated from one another. The common electrode is formed at another surface side of the crystal element. The common electrode is formed over a region opposed to the first excitation electrode and a region opposed to the second excitation electrode. The common electrode forms a first vibrating region between the first excitation electrode and the common electrode. The common electrode forms a second vibrating region between the second excitation electrode and the common electrode. The adsorbing layer is formed at a surface of the common electrode. The adsorbing layer is formed at a position corresponding to one of the first vibrating region and the second vibrating region. The adsorbing layer is configured to adsorb an object to be sensed in a sample solution. The wiring board includes a connecting terminal portion that electrically connects the common electrode, the first excitation electrode, and the second excitation electrode to a measuring apparatus configured to measure oscillation frequencies. The crystal element is secured to the wiring board so as to form a space at one surface side of the first vibrating region and the second vibrating region. The channel forming member is disposed to form a supply channel of sample solution upward of each of the first vibrating region and the second vibrating region. The channel forming member is disposed such that an inferior surface of a left edge and a right edge of the channel forming member is positioned on the common electrode. The channel forming member is formed such that an injection port of the sample solution and a discharge port of the sample solution are opposed to the crystal element.

The sensing sensor of the present disclosure may be configured as follows. The channel may have a height of less than 90 μm. The channel may flow a sample solution from an injection port to a discharge port via a portion above each of the first vibrating region and the second vibrating region by capillarity. Additionally, the channel forming member may be configured such that a channel widens as approaching a downstream direction from an injection port. The channel forming member may be configured such that a channel widens and then narrows as approaching an effluent port. Alternatively, the first vibrating region and the second vibrating region may be symmetrically formed on a crystal element when the channel is viewed from an injection port side to an effluent region side. Adsorption of an object to be sensed to the adsorbing layer may change a unique vibration frequency at a vibrating region where the adsorbing layer is disposed in the first vibrating region and the second vibrating region. A sensing device of the present disclosure may include the above-described sensing sensor and the measuring apparatus.

The present disclosure includes two electrodes for reference and detection at the back surface side of the crystal unit disposed at the sensing sensor. The present disclosure includes the common electrode common to the two electrodes for reference and detection on the front surface side. Further, the inferior surface of the left edge and the right edge of the supply channel for sample solution is positioned on the region covered with the common electrode. Accordingly, the regions of the electrodes and the crystal region are not aligned widthwise of the supply channel, thus eliminating difference of ease of flow of the sample solution. Accordingly, with the supply channel with a low channel height, the sample solution flows through not only the crystal region but equally flows through the entire region of the channel, thus achieving stable measurement.

### BRIEF DESCRIPTION OF THE DRAWINGS

FIG. 1 is a perspective view of a sensing device according to the present disclosure.

FIG. 2 is a perspective view of a sensing sensor constituting the sensing device.

FIG. 3A is a longitudinal cross-sectional side view of the sensing sensor, and FIG. 3B is an enlarged longitudinal cross-sectional side view of a crystal unit and a supply channel.

FIG. 4 is an exploded perspective view illustrating a top surface side of each part of the sensing sensor.

FIG. 5 is an exploded perspective view illustrating an inferior surface side of each part of the sensing sensor.

FIG. 6A is a plan view illustrating a top surface side of the crystal unit constituting the sensing sensor, and FIG. 6B is a plan view illustrating an inferior surface side of the crystal unit.

FIG. 7 is a plan view illustrating a state of the crystal unit installed to the supply channel.

FIG. 8 is a schematic configuration view of the sensing device.

FIG. 9A to FIG. 9C are process views with each view illustrating a different state of measurement with the sensing device.

FIG. 10A and FIG. 10B are explanatory views illustrating how supply liquid flows in a conventional sensing sensor.

FIG. 11A and FIG. 11B are explanatory views illustrating how supply liquid flows in the sensing sensor of the present disclosure.

FIG. 12A to FIG. 12D are process views with each view illustrating a different state of measurement with the sensing device.

### DETAILED DESCRIPTION

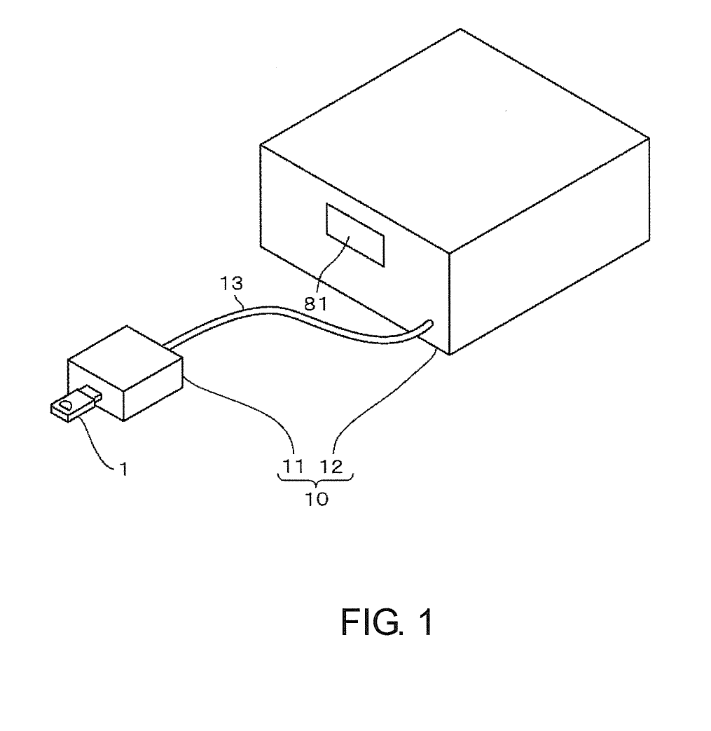

The following describes a sensing device using a sensing sensor according to an embodiment of the present disclosure. This sensing device uses a microfluidic chip. The sensing device can detect, for example, presence/absence of an antigen such as virus in sample solution obtained from nasal cavity swab of a human, for example, influenza virus so as to determine whether the human has been infected with a virus or not with a microfluidic chip. As illustrated in the external perspective view of FIG. 1, the sensing device includes a measuring apparatus 10 and a sensing sensor 1. The measuring apparatus 10 includes an oscillator circuit unit 11 and a main body portion 12. The sensing sensor 1 is attachably/detachably connected to the oscillator circuit unit 11 of the measuring apparatus 10. The oscillator circuit unit 11 is connected to the main body portion 12, for example, via a coaxial cable 13. The main body portion 12 includes, for example, a display unit 81 constituted by a liquid crystal display screen on a front surface. The display unit 81 displays, for example, an output frequency of the oscillator circuit unit 11, a measurement result such as an amount of frequency change, a detection of presence/absence of virus, or a similar result.

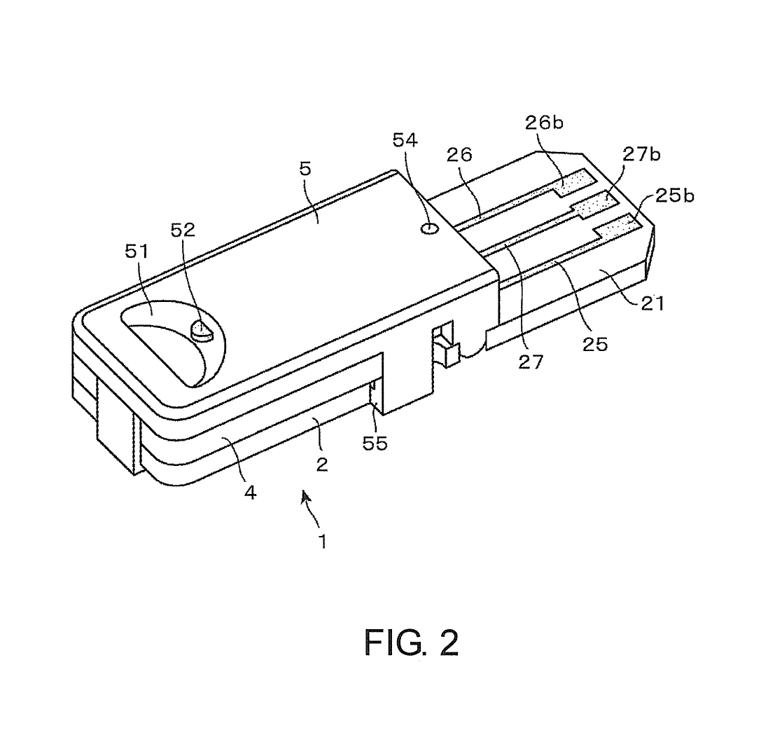

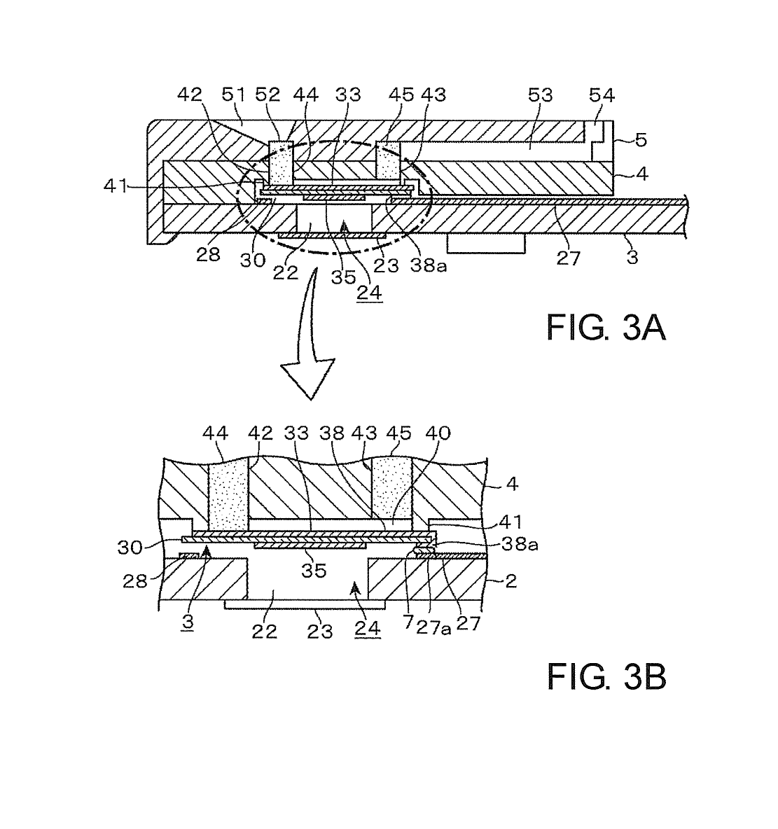

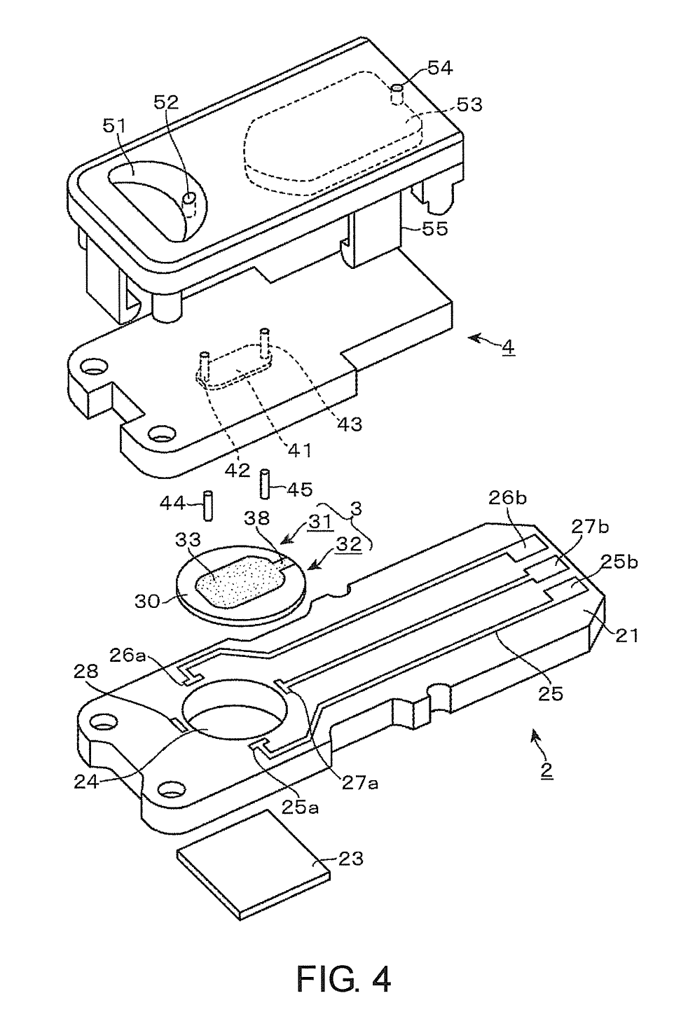

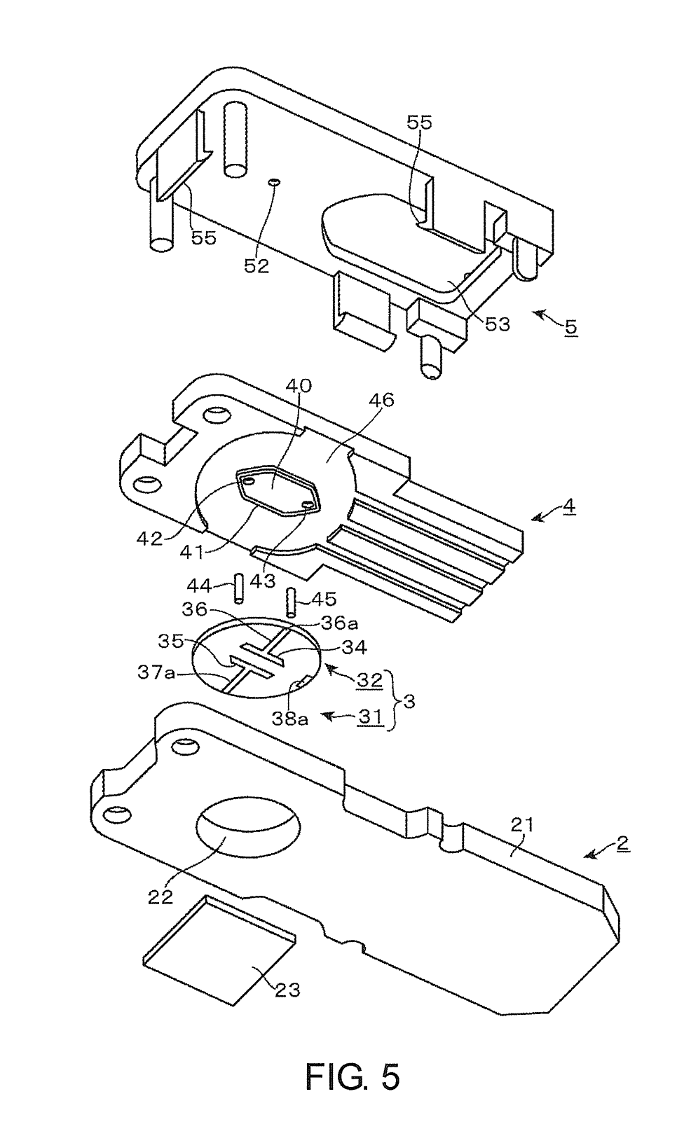

Next, the configuration of the sensing sensor 1 will be described. FIG. 2 is a perspective view of the sensing sensor 1. FIG. 3A and FIG. 3B are longitudinal cross-sectional side views of the sensing sensor 1. FIG. 4 and FIG. 5 are exploded perspective views illustrating a top surface side and an inferior surface side of each part of the sensing sensor 1. The description will be given with reference to FIG. 2 to FIG. 5. The sensing sensor 1 includes a wiring board 2, a crystal unit 3, which could be like a piezoelectric resonator, a channel forming member 4, and an upper lid case 5, which are stacked from the lower side in this order. The wiring board 2 is, for example, an approximately rectangular-shaped board. Suppose that the longitudinal direction is the front-rear direction, the wiring board 2 includes a connecting terminal portion 21 on the rear side. The connecting terminal portion 21 is to be inserted into the oscillator circuit unit 11. The wiring board 2 has a circular-shaped through hole 22 on the front side. A film 23 is fixedly secured to the through hole 22 so as to cover the through hole 22 from the inferior surface side of the wiring board 2. The through hole 22 and the film 23 form a depressed portion 24 on the front surface side of the wiring board 2. The wiring board 2 includes wirings 25, 26, and 27 extending in the longitudinal direction on its top surface. Each of the wirings 25, 26, and 27 is extended from the connecting terminal portion 21 to the outer edge of the depressed portion 24. Each terminal portion 25a, 26a, and 27a is formed at the outer edge of the depressed portion 24. Each terminal portion 25b, 26b, and 27b is formed at the connecting terminal portion 21. A pad 28 is disposed so as to face the terminal portion 27a across the depressed portion 24.

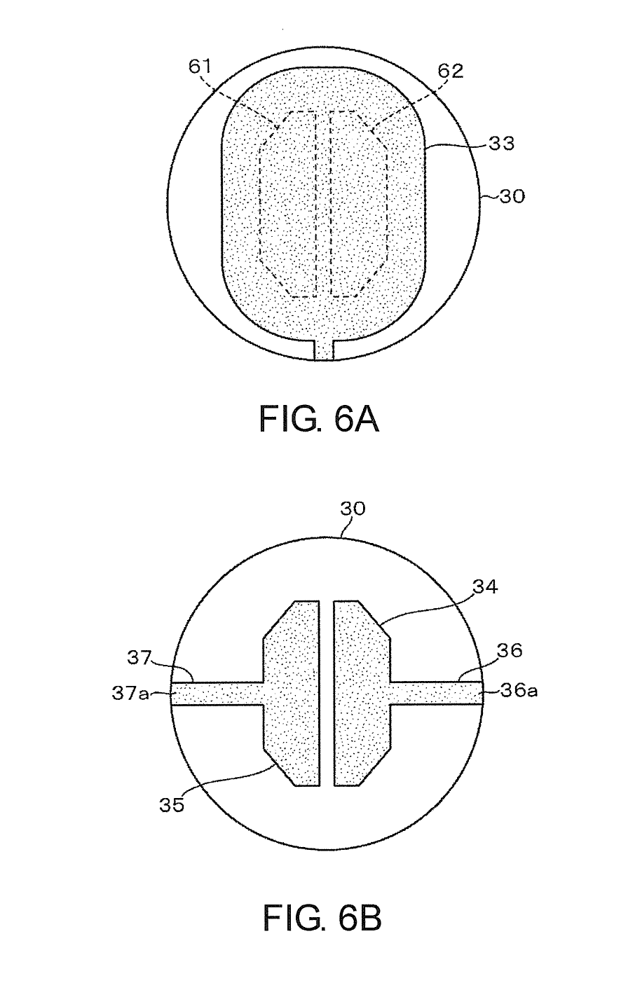

Subsequently, the crystal unit 3 will be described with reference to FIG. 6A and FIG. 6B as well where the top surface and the inferior surface of the crystal unit 3 are illustrated, respectively. The crystal unit 3 is configured to, for example, an AT-cut circular plate-shaped crystal element 30. The crystal unit 3 includes first and second excitation electrodes 34 and 35 on the back surface side. The first and the second excitation electrodes 34 and 35 are made of, for example, gold (Au) and extend in parallel to one another. The crystal unit 3 includes an oval-shaped common electrode 33 on the front surface side. The common electrode 33 is made of, for example, Au and faces the first excitation electrode 34 and the second excitation electrode 35. Regions sandwiched between the common electrode 33 and the first excitation electrode 34, and between the common electrode 33 and the second excitation electrode 35 of this crystal unit 3 become a first and a second vibrating regions 61 and 62, respectively. These first and second vibrating regions 61 and 62 vibrate independently of each other. The regions surrounded by the dotted lines in the drawing indicate regions to which the first and the second excitation electrodes 34 and 35 are projected. The common electrode 33 is formed to have the region between the first and the second vibrating regions 61 and 62 that are electrode regions and exclude a crystal region.

From the common electrode 33, an extraction electrode 38 is extended to the peripheral edge portion of the crystal element 30. This extraction electrode 38 is extended to the side surface of the crystal element 30 and includes a terminal portion 38a at the peripheral edge portion on the backside surface. From the first and the second excitation electrode 34 and 35 as well, extraction electrodes 36 and 37 are extracted to the peripheral edge of the crystal element 30. The extraction electrodes 36 and 37 each form terminal portions 36a and 37a respectively at the peripheral edge portion of the crystal element 30. The regions sandwiched between the common electrode 33 and the extraction electrodes 36, and between the common electrode 33 and the extraction electrodes 36 of this crystal unit 3 also vibrate. However, since each extraction electrode 36 and 37 is sufficiently formed thin, the regions generate small vibration and therefore are excluded from the vibrating region. The region that serves as the first vibrating region 61 on the surface of the common electrode 33 includes an adsorbing layer (not illustrated). The adsorbing layer is constituted of an antibody selectively combines with virus such as influenza virus, which is an object to be sensed. Meanwhile, the region that serves as the second vibrating region 62 on the surface of the common electrode 33 includes an inhibiting film (a blocking film) that inhibits combination of virus and the common electrode 33.

The crystal unit 3 is disposed so as to meet the following. The first and the second excitation electrodes 34 and 35 face the depressed portion 24 of the wiring board 2. The terminal portions 36a, 37a, and 38a are superimposed to the corresponding terminal portions 25a, 26a, and 27a on the wiring board 2, respectively. The terminal portions 36a, 37a, and 38a are adhered to the terminal portions 25a, 26a, and 27a with conductive adhesive 7, respectively. The crystal unit 3 is held so as to face the bottom surface of the depressed portion 24 via a gap. The crystal unit 3 is slightly curved by being pressed by the channel forming member 4, which will be described later. Accordingly, in FIG. 3A and FIG. 3B, the front side of the crystal element 30 is illustrated as if the front side floats from the pad 28. However, the bottom surface of the crystal element 30 contacts the pad 28. Thickness of each of the excitation electrodes 34 and 35 of the crystal unit 3 and each of the wirings 25, 26, and 27 on the wiring board 2; and the terminal portions 25a, 26a, and 27a and the pad 28 are extremely small and therefore an amount of the conductive adhesive 7 is very little. Accordingly, the crystal unit 3 is disposed approximately horizontal to the wiring board 2.

Then, the channel forming member 4 will be described. The channel forming member 4 is formed in a rectangular plate shape made of, for example, polydimethylsiloxane (PDMS). The channel forming member 4 includes a stepped portion 46 on the inferior surface side. The stepped portion 46 goes along outer shapes of the crystal unit 3 and the wirings 25, 26, and 27 so as to house these members. The stepped portion 46 includes two through holes with a diameter of 1.5 mm that serves as an injection port 42 and a discharge port 43. The through holes passing through in the thickness direction and are arranged back and forth. The stepped portion 46 includes a framing portion 41 with a height of 50 μm. The framing portion 41 surrounds the injection port 42 and discharge port 43. The framing portion 41 is formed in a hexagonal shape. The injection port 42 and the discharge port 43 are disposed at the two corners of the framing portion 41 opposed to one another.

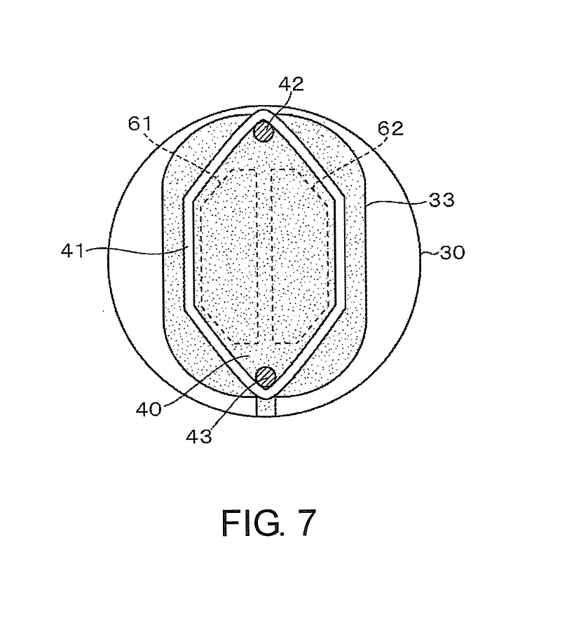

The channel forming member 4 is superimposed from upward of the crystal unit 3 on the front side of the wiring board 2. FIG. 7 illustrates a plan view of a supply channel 40 disposed on the crystal unit 3. As illustrated in FIG. 7, the framing portion 41 falls within the region where the common electrode 33 is disposed. The first and the second vibrating regions 61 and 62 of the crystal unit 3 fall within the region in the framing portion 41. The crystal unit 3 and the channel forming member 4 are closely contacted, thus the supply channel 40, which is a channel, is formed. As described above, the framing portion 41 is formed in a hexagonal shape. Accordingly, the supply channel 40 is configured as follows. The channel of the supply channel 40 widens from the injection port 42 toward downstream. The reference solution flows parallel at the midstream. The channel narrows to the discharge port 43.

The first and the second vibrating regions 61 and 62 are laterally arranged in the direction that the reference solution flows. Accordingly, the reference solution flows each of the first and second vibrating regions 61 and 62 simultaneously and similarly. Moreover, an element other than a load of the object to be sensed is uniformed as much as possible between each of the vibrating regions 61 and 62. Thus, the vibrating regions 61 and 62 can serve as high-reliable reference.

Before the channel forming member 4 is stacked on the wiring board 2, plasma cleaning is performed on the channel forming member 4. Then, the surface of the channel forming member 4 is activated and organic matters are removed from the surface of the channel forming member 4. Purposes of the plasma cleaning is: to facilitate flows at the injection port 42, the discharge port 43, the supply channel 40, and effluent reservoir 53, which will be described later, and to enhance adhesion between the channel forming member 4 and the wiring board 2 and between the channel forming member 4 and the upper lid case 5 to prevent leakage of supply liquid from these gaps.

Then, the upper lid case 5 will be described. The upper lid case 5 has a depressed portion, which serves as an injection port 51, at the front of the top surface side. The injection port 51 has an inclined surface to collect supply liquid dropped to the injection port 51 to the bottom portion. The injection port 51 has a penetrating hole portion 52 at the bottom portion. The hole portion 52 is positioned corresponding to the injection port 42 of the channel forming member 4. The upper lid case 5 includes a depressed portion, which serves as the effluent reservoir 53, at the rear of the inferior surface. The front of the effluent reservoir 53 overlaps the discharge port of the channel forming member 4. The effluent reservoir 53 has an air hole 54 passing through to the top surface side of the upper lid case 5. The effluent reservoir 53 has a larger volume than the injection port 51 so as to accumulate much supply liquid. The effluent reservoir 53 is disposed lower than the injection port 51.

The upper lid case 5 is disposed to cover the channel forming member 4 from upward. The upper lid case 5 is locked with a hook 55. The crystal unit 3, the channel forming member 4, and the upper lid case 5 are stacked on the wiring board 2 in this order. Stacking the upper lid case 5 on the channel forming member 4 connects the hole portion 52 at the injection port 51 to the injection port 42 at the channel forming member 4 side. This closes the inferior surface side of the effluent reservoir 53 with the top surface of the channel forming member 4 and forms a space, thus the effluent reservoir 53 and the discharge port 43 are connected. This forms a sequence of channel continuous as follows: the injection port 51 to the injection port 42 to the supply channel 40 to the discharge port 43 to the effluent reservoir 53.

The injection port 42 and the discharge port 43 are provided with column-shaped filters 44 and 45, which are capillary members, to be attachable/detachable. The filters 44 and 45 are porous bodies configured by bundling straw-shaped chemical fibers made of, for example, cellulose. A large number of small holes are also formed at the sidewalls of the filters 44 and 45. The filter 44 passes through the injection port 42 and the hole portion 52 from the surface of the crystal unit 3 and projects to the bottom portion of the injection port 42. The filter 45 is disposed at the discharge port 43. The lower end of the filter 45 is disposed to be the ceiling height of the supply channel 40 while the distal end projects to the effluent reservoir 53.

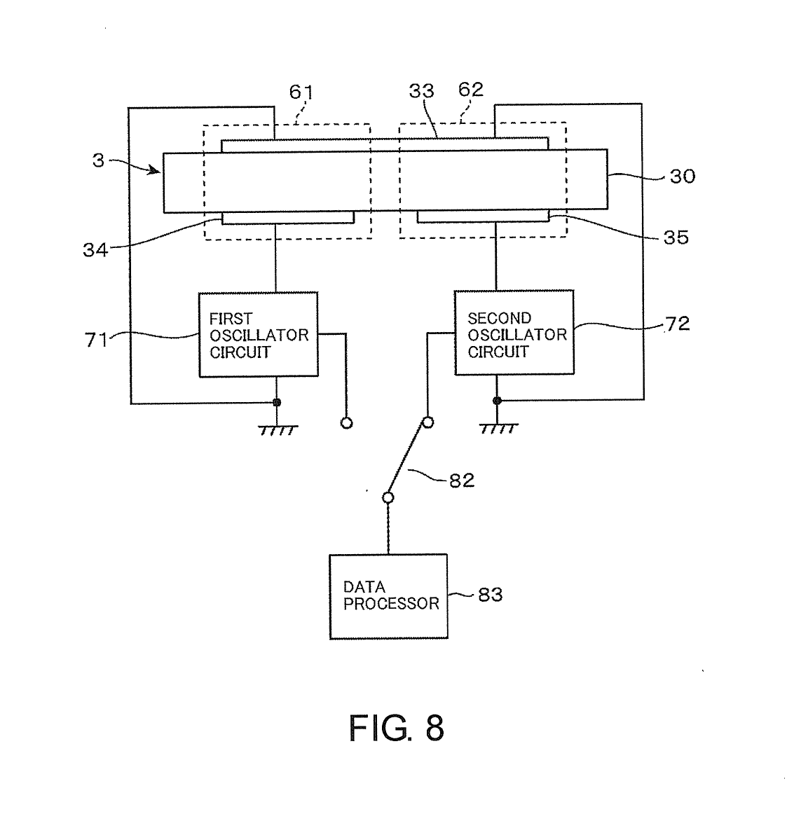

Insertion of the above-described connecting terminal portion 21 of the sensing sensor 1 into the oscillator circuit unit 11 electrically connects the terminal portions 25a, 26a, and 27a of the connecting terminal portion 21 to connecting terminal portions (not illustrated) formed corresponding to the terminal portions 25a, 26a, and 27a at the oscillator circuit unit 11, thus the sensing device is configured. As illustrated in FIG. 8, the oscillator circuit unit 11 includes a first oscillator circuit 71 and a second oscillator circuit 72 constituted of, for example, Colpitts circuits. The first oscillator circuit 71 oscillates the first vibrating region 61, and the second oscillator circuit 72 oscillates the second vibrating region 62.

The main body portion 12 includes a switch 82 and a data processor 83. Output sides of the first and the second oscillator circuits 71 and 72 in the oscillator circuit unit 11 are connected to the main body portion 12 via the coaxial cable 13 and then are connected to the switch 82 in the main body portion 12. The data processor 83 is disposed at the latter part of the switch 82. The data processor 83 digitalizes a frequency signal, which is an input signal, and obtains time-series data of an oscillation frequency “F1” and time-series data of an oscillation frequency “F2.” “The oscillation frequency “F1” is output from the first oscillator circuit 71 while the oscillation frequency “F2” is output from the second oscillator circuit 72. The sensing device of the present disclosure intermittently oscillates the first oscillator circuit 71 and the second oscillator circuit 72 using the switch 82. The switch 82 alternately switches a channel 1 and a channel 2. The channel 1 connects the data processor 83 and the first oscillator circuit 71 while the channel 2 connects the data processor 83 and the second oscillator circuit 72. This ensures obtaining stable frequency signals by avoiding interference between the two vibrating regions 61 and 62 of the sensing sensor 1. These frequency signals are, for example, time shared and retrieved by the data processor 83. The data processor 83 calculates the frequency signals in the form of, for example, digital values, performs arithmetic processing based on the calculated time sharing data of digital values, and causes the display unit 81 to display an operation result such as presence/absence of an antigen.

Actions of the sensing sensor 1 according to the embodiment of the present disclosure will be described. Hereinafter, this description denotes supply liquid as follows. A supply liquid that does not include the object to be sensed and creates liquid atmosphere around the crystal unit 3 is denoted as reference solution. A supply liquid supplied to the sensing sensor 1 as a target for determination whether the object to be sensed is included or not is denoted as sample solution. In this example, saline is employed as the reference solution. As the sample solution, the solution where nasal cavity swab of a human is diluted with saline is employed.

Inserting the sensing sensor 1 into the oscillator circuit unit 11 and starting the measuring apparatus 10 oscillate each vibrating region 61 and 62 of the crystal unit 3. Then, the frequency signals F1 and F2 corresponding to the respective frequency signals are taken out.

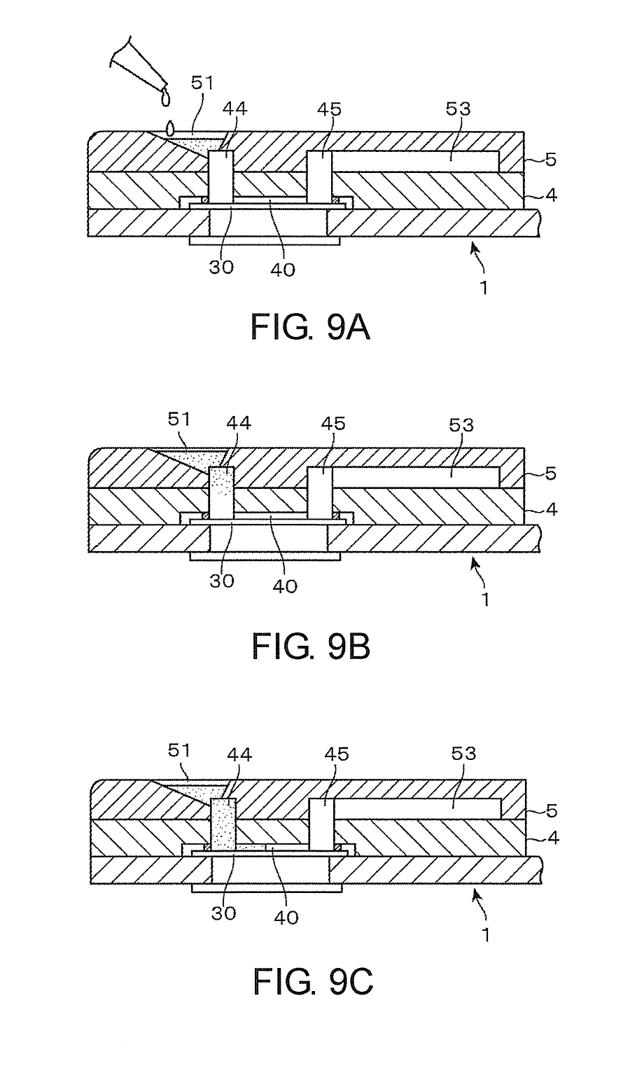

Next, as illustrated in FIG. 9A, a user drops, for example, a reference solution (saline) to the injection port 51 with a syringe. In the sensing sensor 20 according to the embodiment of the present disclosure, the injection port 51 is positioned higher than the effluent reservoir 53. Additionally, the injection port 42 and the discharge port 43 are thinned, and the filters 44 and 45 are inserted in the respective ports. Accordingly, the supply liquid flows by capillarity of the filters 44 and 45 disposed at the injection port 42 and the discharge port 43 and siphon effect utilizing difference in height between the injection port 51 and the effluent reservoir 53. Thus, the supply liquid is supplied to and discharged from the end of the supply channel 40.

The reference solution dropped to the injection port 51 is absorbed into the filter 44 at the injection port 42. Then, gravitation causes the reference solution to fall in the filter 44, thus the reference solution is supplied in the supply channel 40. Accordingly, the supply liquid flows in the supply channel 40. Here, the difference in flow of the supply liquid depending on the height of the supply channel 40 and the layout of the bottom surface of the supply channel 40 is examined. The height of the channel in the description means a distance from the electrode to the ceiling.

First, the following case is examined. Two electrodes are arranged at the region of the crystal unit 3 at the bottom surface of the supply channel 40. The crystal region of the crystal unit 3 is highly hydrophilic compared with the surface of the electrodes; therefore, the region of the crystal surface easily gets wet with water. The electrodes are disposed on the surface of the plate-shaped crystal element 30; therefore, their heights differ by the thickness of the electrodes. Accordingly, in the case where the two electrodes are arranged at the region of the crystal unit 3 at the bottom surface of the supply channel 40, and the supply liquid is poured to the supply channel 40, the supply liquid tends to flow through the crystal region without the electrodes.

However, if the height of the supply channel 40 is high, for example, 300 a distance between the ceiling surface and the bottom surface of the supply channel 40 becomes long, an amount of liquid flowing through the supply channel 40 at a time would be increased. Accordingly, even if an attempt is made for the supply liquid to flow through only the crystal region, the surface tension between the ceiling surface and the bottom surface of the supply channel 40 fails to control the flow due to large amount of the supply liquid. This causes flow of the supply liquid also to the region with the electrodes, thus liquid flows to the entire supply channel 40.

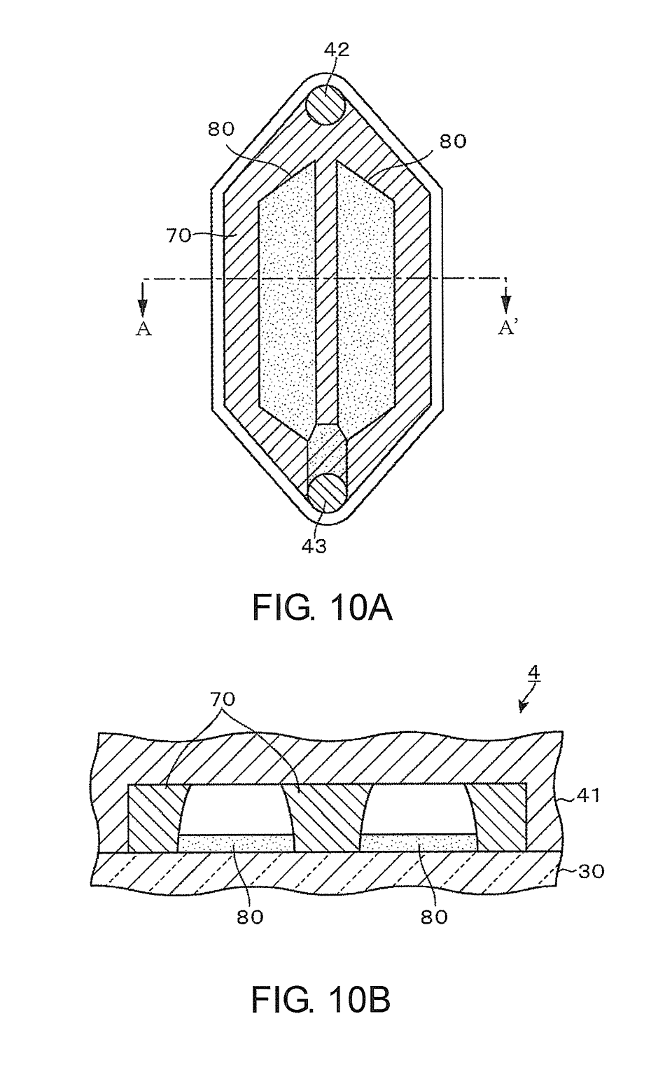

Meanwhile, the flow of the supply liquid in the case where the height of the supply channel 40 is equal to or less than 90 μm, for example, 50 μm, will be described with reference to FIG. 10A, which is a plan view of the supply channel 40, and FIG. 10B, which is a cross-sectional view taken along the line A-A′ in the plan view. With the supply channel 40 with a low height, since the cross-sectional area of the supply channel 40 is narrow, the amount of the supply liquid 70 flowing in the supply channel 40 decreases. Accordingly, when the supply liquid 70 attempts to flow through the crystal region, the amount of the supply liquid 70 attempting to flow into the region of a detection electrode 80 becomes less. Then, the surface tension by the liquid surface connecting the ceiling surface and the bottom surface of the supply channel 40 shuts off flowing out of the supply liquid 70 to the region of the detection electrode 80, resulting in flow of the supply liquid 70 avoiding the region of the detection electrode 80.

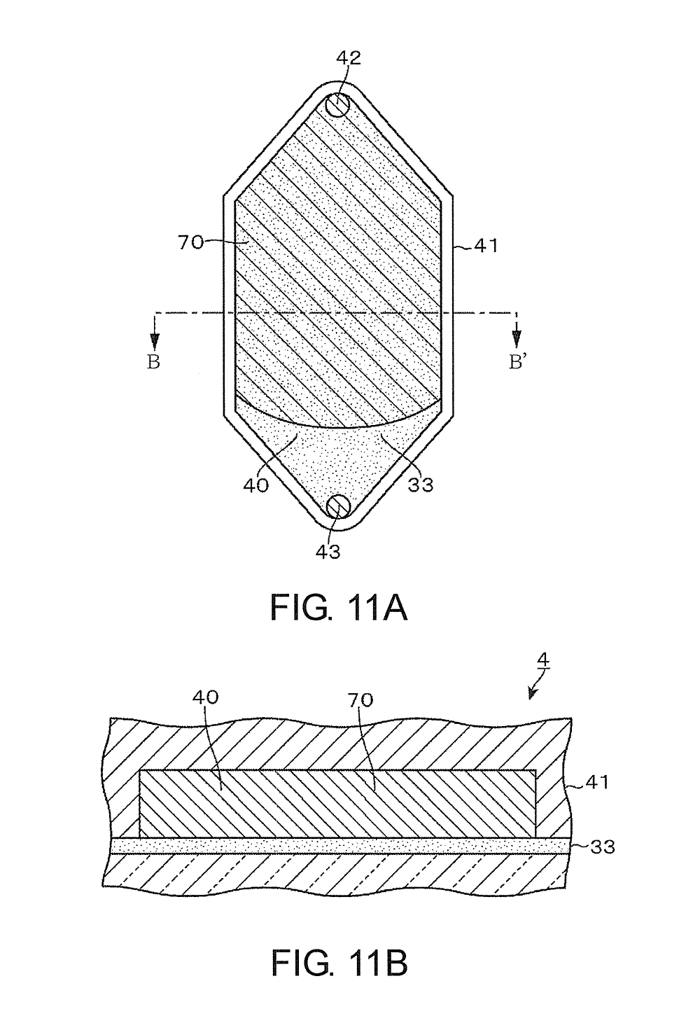

Then, the case where the entire region of the bottom surface of the supply channel 40 is covered with the common electrode 33 is examined. FIG. 11A is a plan view of when the supply liquid is poured to the supply channel 40 whose entire bottom surface is covered with the common electrode 33. FIG. 11B is a cross-sectional view taken along the line B-B′ of the plan view. The entire bottom surface of the supply channel 40 is covered with the common electrode 33. This eliminates difference in height of the crystal region, also making no difference in hydrophobicity. Therefore, as illustrated in FIG. 11A and FIG. 11B, the supply liquid 70 equally flows all surfaces of the supply channel 40. The common electrode 33 covers from the lower side of the injection port 42 to the lower side of the discharge port 43. This eliminates regions of different hydrophobicity and difference in step of the bottom surface in the middle of flow from the injection port 42 to the discharge port 43. If the bottom surface of the supply channel 40 differs in hydrophobicity and has a step, the flow rate varies. This easily generates air bubble in the channel and causes a failure such as tendency of adhesion of air bubble to the stepped part. Covering the entire bottom surface of the channel with the common electrode 33 allows reducing possibility of such failure.

Thus, in the configuration of the above-described embodiment, the supply liquid (the reference solution) 70 flows along the shape of the supply channel 40, spreading fanwise on the entire bottom surface of the supply channel 40. Flow of the reference solution changes environmental atmosphere of the first and the second vibrating regions 61 and 62 of the crystal unit 3 at the supply channel 40 from a gas phase to a liquid phase. Increase in viscosity of the liquid decreases the output frequencies F1 and F2 of each channel.

In the above-described sensing sensor 1, the electrode at the front surface side is configured as the common electrode 33. Electrodes at the inferior surface side are formed as the first and the second excitation electrodes 34 and 35 arranged widthwise with respect to the channel direction. The common electrode 33 is configured as a grounding electrode, and the first and the second excitation electrodes 34 and 35 at the inferior surface side are connected to the first oscillator circuit 71 and the second oscillator circuit 72, respectively. Oscillation of the crystal unit 3 concentrates vibration energy at the proximity of the electrodes by energy confinement effect. Accordingly, in the above-described crystal unit 3, the vibration energy is increased at the region where the first and the second excitation electrodes 34 and 35 are disposed at the inferior surface side illustrated in FIG. 5. Thus, the frequency signal oscillated from the first oscillator circuit 71 is output independently of the frequency signal oscillated from the second oscillator circuit 72, respectively.

From the electrodes at the respective first and the second vibrating regions 61 and 62, frequency signals corresponding to the respective frequencies are taken out and output from the respective channels. These frequency signals are time shared and retrieved by a measurement circuit portion and A/D converted, thus each digital value is signal-processed. The frequencies “F1 and F2” are taken out from the frequency signals from the two channels. Then, an operation to store these frequencies in a memory at approximately the same timing (for example, delay of ½ seconds) is repeated.

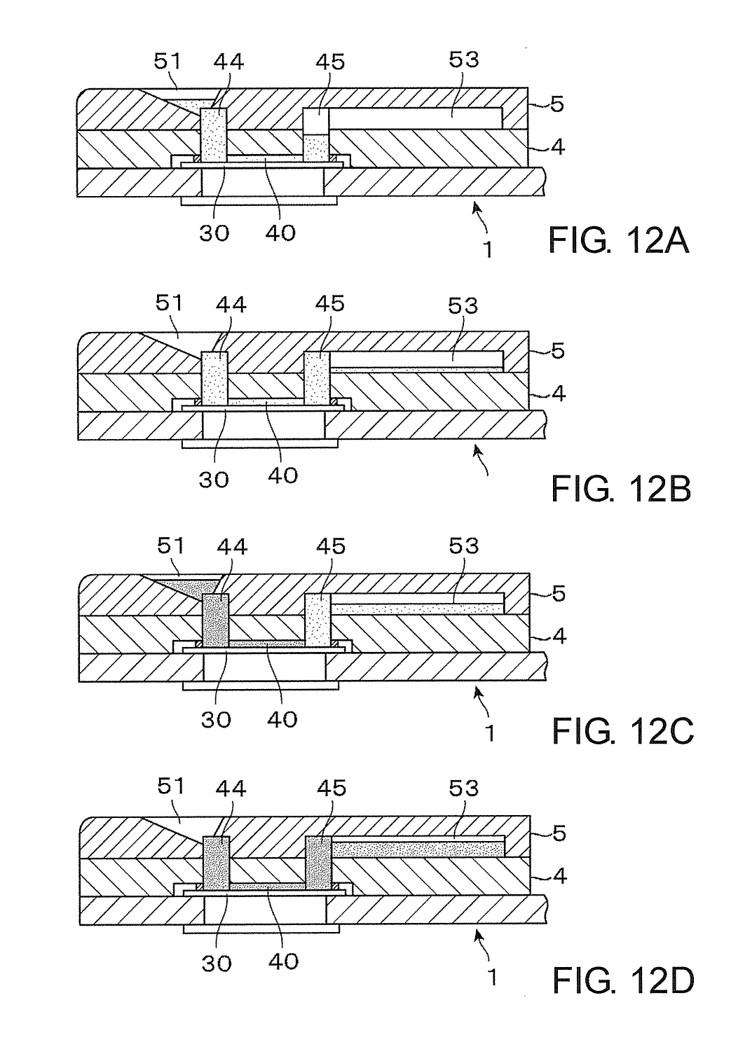

Subsequently, the sample solution is dropped to the injection port 51. As illustrated in FIG. 12D, the sample solution is absorbed into the filter similarly to the reference solution and falls due to gravitation. This drifts the reference solution remaining at the filter 44 to downstream. Then, all the reference solution flows through the supply channel 40 to the discharge port 43. Similarly to the reference solution, the sample solution is supplied to the supply channel 40 by capillarity of the filters 44 and 45. The sample solution flows spreading along the outer edge of the supply channel 40, and the liquid phase inside of the supply channel 40 is replaced by the sample solution from the reference solution.

When the sample solution filling the supply channel 40 includes the antigen that is the object to be sensed, the antigen is adsorbed to the antibody disposed at the adsorbing layer by antigen-antibody reaction. The adsorbing layer is disposed at the inferior surface side in the common electrode 33 to which the first excitation electrode is projected, namely, at the first vibrating region 61. Mass of the antigen adsorbed by the adsorbing layer is loaded to the mass of the electrode at the region.

If the sample solution includes the antigen, the frequency “F1” taken out from the first vibrating region 61 varies depending on the temperature and the viscosity of the sample solution. In addition, the antigen is adsorbed to the adsorbing layer by antigen-antibody reaction, thus the frequency is further reduced by effect of mass load. Meanwhile, from the channel 2, which is connected to the second vibrating region 62, the frequency “F2” varies depending on the temperature and the viscosity of the sample solution is taken out. This frequency change results in reduction of the frequency “F1-F2.” The sample solution flows from the supply channel 40 to the discharge port 43, being accumulated to the effluent reservoir 53. When the amount of liquid in the effluent reservoir 53 rises and hydraulic pressure increases, the movement of the sample solution from the injection port 42 stops. The sample solution without antigen flows similarly to the case of the sample solution with antigen. However, a load of mass due to the above-described antigen-antibody reaction is not applied to the first vibrating region 61. From the channel 1 and the channel 2, the frequencies “F1” and “F2”, which vary depending on the temperature and the viscosity of the sample solution, are taken out, thus the frequency difference changes become few.

An average value “a” denotes a “F1-F2” value at time when the supply channel 40 is filled with the reference solution. An average value “b” denotes a “F1-F2” value at some point of time when the inside of the supply channel 40 is replaced by the sample solution from the reference solution and detection is assumed to be performed. For example, the average value “a” and the average value “b” are operated. Additionally, the difference value of both average values, a-b, is calculated. If the difference value is within the predetermined allowable value, it is determined that the antigen is absent in the sample solution. If the difference value a-b exceeds the allowable value, it is determined that the antigen is present in the sample solution. The result is displayed on the display unit 81.

According to the above-described embodiment, the two excitation electrodes 34 and 35, which are for reference and detection, are disposed at the back surface side of the crystal unit 3 where the sensing sensor 1 is disposed. Additionally, the common electrode 33 common to the two excitation electrodes 34 and 35 for reference and detection is disposed at the front surface side. Further, a left edge and a right edge of the inferior surface of the supply channel 40 is positioned on a region covered with the common electrode 33. This uniforms the bottom surface of the supply channel 40, thus eliminating difference of ease of flow of the sample solution. Accordingly, with the supply channel 40 with a low channel height, the sample solution flows through not only the crystal region but equally flows through the entire region of the supply channel 40, thus achieving stable measurement.

The sensing sensor of the present disclosure may include the first and the second vibrating regions arranged in the flowing direction of the supply channel 40. Further, the sensing sensor of the present disclosure may be applied to a sensing sensor for a flow-based measurement.

### WORKING EXAMPLE

Data for confirming an effect in the case where the height of the channel of the sensing sensor 1 is narrowed and the capacity of the supply channel 40 is reduced is shown. The following working example was conducted. The common electrode 33 was disposed at the front surface side of the crystal unit 3 so as to cover the entire bottom surface of the supply channel 40. With the channel height of 50 μm, C-reactive protein with a concentration of 10 ng/ml was detected. As a comparative example, the measurement was performed with the sensing sensor similarly configured with the working example except that the channel height was set to 300 μm. Table 1 shows values of F1-F2 output in each sensing sensor according to the working example and the comparative example.

TABLE 1

| | Channel Capacity (μm) | F1-F2 (Hz) |
|---|---|---|
| Working Example | 0.83 | 6.04 |
| Comparative Example | 5.00 | 2.13 |

As illustrated in Table 1, with the sensing sensor of the comparative example, F1-F2 was detected as 2.13 Hz. Meanwhile, with the sensing sensor of the working example, F1-F2 was detected as 6.04 Hz. Accordingly, lowering the channel height of the sensing sensor ensures the increased detection sensitivity.

What is claimed is:

1. A sensing sensor, comprising:
a first excitation electrode and a second excitation electrode disposed at one surface side of a crystal element, the first excitation electrode and the second excitation electrode being laterally separated from one another;
a common electrode formed at another surface side of the crystal element, the common electrode being formed over a region opposed to the first excitation electrode and a region opposed to the second excitation electrode, the common electrode forming a first vibrating region between the first excitation electrode and the common electrode, the common electrode forming a second vibrating region between the second excitation electrode and the common electrode;
an adsorbing layer formed at a surface of the common electrode, the adsorbing layer being formed at a position corresponding to one of the first vibrating region and the second vibrating region, the adsorbing layer being configured to adsorb an object to be sensed in a sample solution;
a wiring board that includes a connecting terminal portion that electrically connects the common electrode, the first excitation electrode, and the second excitation electrode to a measuring apparatus configured to measure oscillation frequencies, the crystal element being secured to the wiring board so as to form a space at one surface side of the first vibrating region and the second vibrating region; and
a channel forming member disposed to form a supply channel of sample solution upward of each of the first vibrating region and the second vibrating region, the channel forming member being disposed such that an inferior surface of a left edge and a right edge of the channel forming member being positioned on the common electrode, the channel forming member being formed such that an injection port of the sample solution and a discharge port of the sample solution being opposed to the crystal element.

2. The sensing sensor according to claim 1, wherein
the channel has a height of less than 90 μm.

3. The sensing sensor according to claim 1, wherein
the channel flows a sample solution from an injection port to a discharge port via a portion above each of the first vibrating region and the second vibrating region by capillarity.

4. The sensing sensor according to claim 1, wherein
the channel forming member is configured such that a channel widens as approaching a downstream direction from an injection port.

5. The sensing sensor according to claim 4, wherein
the channel forming member is configured such that a channel widens and then narrows as approaching an effluent port.

6. The sensing sensor according to claim 1, wherein
the first vibrating region and the second vibrating region are symmetrically formed on a crystal element when the channel is viewed from an injection port side to an effluent region side.

7. The sensing sensor according to claim 1, wherein
adsorption of an object to be sensed to the adsorbing layer changes a unique vibration frequency at a vibrating region where the adsorbing layer is disposed in the first vibrating region and the second vibrating region.

8. A sensing device, comprising:
a measuring apparatus; and
a sensing sensor comprising:
a first excitation electrode and a second excitation electrode disposed at one surface side of a crystal element, the first excitation electrode and the second excitation electrode being laterally separated from one another;
a common electrode formed at another surface side of the crystal element, the common electrode being formed over a region opposed to the first excitation electrode and a region opposed to the second excitation electrode, the common electrode forming a first vibrating region between the first excitation electrode and the common electrode, the common electrode forming a second vibrating region between the second excitation electrode and the common electrode;
an adsorbing layer formed at a surface of the common electrode, the adsorbing layer being formed at a position corresponding to one of the first vibrating region and the second vibrating region, the adsorbing layer being configured to adsorb an object to be sensed in a sample solution;
a wiring board that includes a connecting terminal portion that electrically connects the common electrode, the first excitation electrode, and the second excitation electrode to the measuring apparatus configured to measure oscillation frequencies, the crystal element being secured to the wiring board so as to form a space at one surface side of the first vibrating region and the second vibrating region; and
a channel forming member disposed to form a supply channel of sample solution upward of each of the first vibrating region and the second vibrating region, the channel forming member being disposed such that an inferior surface of a left edge and a right edge of the channel forming member being positioned on the common electrode, the channel forming member being formed such that an injection port of the sample solution and a discharge port of the sample solution being opposed to the crystal element.

9. The sensing device according to claim 8, wherein
the channel has a height of less than 90 μm.

10. The sensing device according to claim 8, wherein
the channel flows a sample solution from an injection port to a discharge port via a portion above each of the first vibrating region and the second vibrating region by capillarity.

11. The sensing device according to claim 8, wherein
the channel forming member is configured such that a channel widens as approaching a downstream direction from an injection port.

12. The sensing device according to claim 11, wherein
the channel forming member is configured such that a channel widens and then narrows as approaching an effluent port.

13. The sensing device according to claim 8, wherein
the first vibrating region and the second vibrating region are symmetrically formed on a crystal element when the channel is viewed from an injection port side to an effluent region side.

14. The sensing device according to claim 8, wherein
adsorption of an object to be sensed to the adsorbing layer changes a unique vibration frequency at a vibrating region where the adsorbing layer is disposed in the first vibrating region and the second vibrating region.
